(19) United States
(12) Patent Application Publication
(10) Pub. No.: US 2017/0146702 A1
(43) Pub. Date: May 25, 2017

(54) ADHESIVE COMPOSITION, ADHESIVE FILM, BRIGHTNESS ENHANCEMENT FILM, AND BACKLIGHT UNIT COMPRISING SAME

(71) Applicant: LG CHEM, LTD., Seoul (KR)

(72) Inventors: Seung A WOO, Daejeon (KR); Dong Ryul KIM, Daejeon (KR); Young Whan PARK, Daejeon (KR); Jung Sup SHIM, Daejeon (KR); Yoongyung CHO, Daejeon (KR); Sung Kyung PARK, Daejeon (KR)

(73) Assignee: LG CHEM, LTD., Seoul (KR)

(21) Appl. No.: 15/318,590

(22) PCT Filed: Jun. 12, 2015
(86) PCT No.: PCT/KR2015/005964

§ 371 Date: Jan. 23, 2017

(30) Foreign Application Priority Data
Jun. 13, 2014 (KR) 10-2014-0072466
Jun. 13, 2014 (KR) 10-2014-0072467

(51) Int. Cl. G02B 5/02; C09J 11/04; F21V 8/00; C09K 11/56; C09K 11/88; C09J 123/22; C09J 7/00

(52) U.S. Cl. CPC G02B 5/0231; C09J 123/22; C09J 11/04; C09J 7/00; C09K 11/565; C09K 11/883; G02B 6/0011

(57) ABSTRACT

Provided are an adhesive composition, an adhesive film, a brightness enhancing film including the adhesive film, and a backlight unit including the same.

### TECHNICAL FIELD

This application claims priority to and the benefit of Korean Patent Application Nos. 10-2014-0072466 and 10-2014-0072467 filed in the Korean Intellectual Property Office on Jun. 13, 2014, the entire contents of which are incorporated herein by reference.

The present invention provides an adhesive composition, an adhesive film, a brightness enhancing film including the adhesive film, and a backlight unit including the same.

### BACKGROUND ART

A quantum dot is a material having a crystal structure with a size of several nanometers and consists of hundreds or thousands of atoms. Because the quantum dot has a very small size, a quantum confinement effect is shown. The quantum confinement effect means a phenomenon in which when an object is decreased to a nano size or less, an energy band gap of the object is increased. Accordingly, when light of a wavelength having larger energy than the energy band gap is incident to the quantum dot, the quantum dot is in an excited state by absorbing the energy of the light and falls to a ground state while emitting light of a specific wavelength. The wavelength of the emitted light is determined by energy corresponding to the band gap.

Generally, as the size of the quantum dot is decreased, light having a short wavelength is emitted and as the size is increased, the light having a long wavelength is emitted. This is a unique electrical and optical characteristic different from conventional semiconductor materials. Accordingly, the quantum dot may implement a desired light emitting characteristic by adjusting a size, a composition, and the like.

However, due to problems such as characteristics of quantum dots vulnerable to moisture and oxygen and light leakage and the like when forming a film, it is difficult to commercialize the film using quantum dots.

### DETAILED DESCRIPTION OF THE INVENTION

### Technical Problem

The present invention has been made in an effort to provide an adhesive composition, an adhesive film, a brightness enhancing film including the adhesive film, and a backlight unit including the same.

### Technical Solution

An exemplary embodiment of the present invention provides an adhesive film including at least one quantum dot; an olefin polymer; and solvent, in which at least one of repeated units of the olefin polymer is derived from isobutylene.

Another exemplary embodiment of the present invention provides an adhesive film prepared by using the adhesive composition.

Yet another exemplary embodiment of the present invention provides an adhesive film including at least one quantum dot in a substrate including an olefin polymer, in which at least one of repeated units of the olefin polymer is derived from isobutylene.

Still another exemplary embodiment of the present invention provides a brightness enhancing film including the adhesive film and a light scattering layer provided on at least one surface of the adhesive film.

Still yet another exemplary embodiment of the present invention provides a backlight unit including the brightness enhancing film; a light source unit including a light source generating light; and a light guide plate guiding the light.

### Advantageous Effects

According to the exemplary embodiment of the present invention, in the adhesive composition and the adhesive film prepared using the same, it is possible to prevent the deterioration of performance of the quantum dots from an oxidization environment by oxygen or moisture due to an excellent external blocking property.

Further, the adhesive composition and the adhesive film prepared using the same have advantages in that the quantum dots are stably provided, the quantum dots are evenly dispersed, and the deviation in performance is small.

According to the exemplary embodiment of the present invention, the adhesive composition and the adhesive film prepared using the adhesive composition have an advantage of having excellent adhesion with other substances and high application.

Further, according to the exemplary embodiment of the present invention, the brightness enhancing film has an advantage of having excellent light extraction efficiency by removing an air gap between the adhesive film including quantum dots and the light scattering layer.

Further, according to the exemplary embodiment of the present invention, the prism sheet can implement excellent light emission efficiency by removing the air gap between the adhesive film including quantum dots and the light scattering layer.

### BRIEF DESCRIPTION OF DRAWINGS

FIG. 1 illustrates a change graph of photo luminescence (PL) intensity before and after constant temperature and humidity of an adhesive film according to Example 1.

FIG. 2 illustrates a change graph of photo luminescence (PL) intensity before and after constant temperature and humidity of an acrylate film according to Comparative Example 1.

FIG. 3 illustrates a change graph of photo luminescence (PL) intensity during constant temperature and humidity of the films according to Example 1 and Comparative Example 1.

FIG. 4 is a fluorescent image of the films according to Example 1 and Comparative Example 1.

FIG. 5 is a fluorescent image of the films according to Example 2 and Comparative Example 2.

FIG. 6 illustrates a change graph of photo luminescence (PL) intensity before and after constant temperature and humidity of an adhesive film according to Example 3.

FIG. 7 illustrates a change graph of photo luminescence (PL) intensity before and after constant temperature and humidity of an adhesive film according to Comparative Example 3.

FIG. 8 illustrates a change graph of photo luminescence (PL) intensity during constant temperature and humidity of the films according to Example 3 and Comparative Example 3.

FIGS. 9 and 10 illustrate a stacked structure of a brightness enhancing film according to an exemplary embodiment of the present invention.

FIG. 11 illustrates a comparison graph of a photo luminescence (PL) intensity according to presence of an air gap between a light extraction layer and a color conversion layer in brightness enhancing films according to Example 4 and Comparative Example 4.

### EXPLANATION OF REFERENCE NUMERALS AND SYMBOLS

101, 102: Light scattering layer
201: Adhesive film

### BEST MODE

In this specification, it will be understood that when a member is referred to as being “on” another member, it can be directly on the other member or intervening members may also be present.

Throughout the specification, unless explicitly described to the contrary, the word “comprise” and variations such as “comprises” or “comprising” will be understood to imply the inclusion of stated elements but not the exclusion of any other elements.

Hereinafter, the present invention will be described in more detail.

An exemplary embodiment of the present invention provides an adhesive composition including at least quantum dot; an olefin polymer; and a solvent, in which at least one of repeated units of the olefin polymer is derived from isobutylene.

According to the exemplary embodiment of the present invention, at least one of repeated units of the olefin polymer may include two methyl side chains.

According to the exemplary embodiment of the present invention, the olefin polymer may have a glass transition temperature of −50° C. or less.

According to the exemplary embodiment of the present invention, the olefin polymer may be a rubber phase.

According to the exemplary embodiment of the present invention, a molecular weight of the olefin polymer may be 10,000 g/mol or more and 1,000,000 g/mol or less.

According to the exemplary embodiment of the present invention, the olefin polymer may be a random copolymer formed by polymerizing isobutylene or a random copolymer formed by polymerizing isopropylene and isobutylene. Particularly, according to the exemplary embodiment of the present invention, the olefin polymer may be a random copolymer of isobutylene.

According to the exemplary embodiment of the present invention, at least some or all of the surfaces of the quantum dots may be coated with a transparent organic or inorganic polymer material.

The “transparency” of the present invention means that transmittance of visible light rays is 50% or more, specifically, 75% or more.

According to the exemplary embodiment of the present invention, the organic or inorganic polymer may have transparency enough not to affecting wavelength conversion performance of the quantum dot.

According to the exemplary embodiment of the present invention, the polymer material may include one or more selected from a group consisting of polyethylene, polypropylene, polyethylene oxide, polysiloxane, polyphenylene, polythiophene, poly (phenylene-vinylene), polyepoxy, polyacrylate, polyketone, polymethacrylate, polyacetylene, polyisoprene, polyurethane, polyester, polyacetylene, polystyrene, polyester, polycarbonate, polyamide, polyimide, polyolefin, and polymaleic anhydride.

According to the exemplary embodiment of the present invention, the adhesive composition may further include at least one additive selected from the group consisting of a crosslinking compound, a photoinitiator, a thermal initiator and a tackifier.

According to the exemplary embodiment of the present invention, the crosslinking compound may include at least one selected from the group consisting of compounds obtained by esterifying, with α,β-unsaturated-carboxylic aids, polyalcohols, such as mixtures (TO-2348 and TO-2349 by Japan Donga Synthesis Corporation as trade names) of dipentaerythritol hexa(meth)acrylate with acidic modification such as hexanedioldi(meth) acrylate, ethyleneglycol di(meth)acrylate, polyethylene glycol di(meth)acrylate having 2 to 14 ethylene groups, trimethylolpropane di(meth)acrylate, trimethylolpropane tri(meth)acrylate, pentaerythritol tri(meth)acrylate, pentaerythritol tetra(meth)acrylate, 2-trisacryloyloxymethylethylphthalic acid, propylene glycol di(meth)acrylate having 2 to 14 propylene groups, dipentaerythritol penta(meth)acrylate, dipentaerythritol hexa(meth)acrylate, and dipentaerythritol penta(meth)acrylate; compounds obtained by adding (meth)acrylic acid to a compound containing a glycidyl group, such as a trimethylolpropane triglycidyl ether acrylic acid adduct and a bisphenol A diglycidyl ether acrylic acid adduct; ester compounds of a compound having a hydroxyl group or an ethylenically unsaturated bond such as phthalic diester of β-hydroxyethyl (meth)acrylate and a toluene diisocyanate adduct of β-hydroxyethyl (meth)acrylate with a polyvalent carboxylic acid, or adducts with polyisocyanate; (meth) acrylate alkylester such as methyl(meth)acrylate, ethyl(meth)acrylate, butyl(meth)acrylate and 2-ethylhexyl(meth)acrylate; and 9,9′-bis[4-(2-acryloyloxyethoxy)phenyl] fluorene. The crosslinking compound is not limited to these compounds and may use general compounds known in the art.

According to the exemplary embodiment of the present invention, the photoinitiator may be substituted with 1 or 2 or more substituents selected from the group consisting of a triazine compound, a biimidazole compound, an acetophenone compound, an O-acyloxime compound, a thioxanthone compound, a phosphine oxide compound, a coumarin compound and a benzophenone compound.

Particularly, according to the exemplary embodiment of the present invention, the photoinitiator may use a triazine compound, such as 2,4-trichloromethyl-(4′-methoxyphenyl)-6-triazine, 2,4-trichloromethyl-(4′-methoxystyryl)-6-triazine, 2,4-trichloro methyl-(triphenyl(fipronil))-6-triazine, 2,4-trichloromethyl-(3′,4′-dimethoxyphenyl)-6-triazine, 3-{4-[2,4-bis trichloromethyl)-s-triazin-6-yl] phenylthio} propanoic acid, 2,4-trichloromethyl-(4′-ethylbiphenyl)-6-triazine or 2,4-trichloromethyl(4′-methylbiphenyl)-6-triazine; a biimidazol-based compound such as 2,2′-bis(2-chlorophenyl)-4,4′,5,5′-tetraphenylbiimidazole or 2,2′-bis(2,3-dichlorophenyl)-4,4′,5,5′-tetraphenylbiimidazole; an acetophenone-based compound, such as 2-hydroxy-2-methyl-1-phenylpropan-1-one, 1-(4-isopropylphenyl)-2-hydroxy-2-methylpropan-1-one, 4-(2-hydroxyethoxy)-phenyl (2-hydroxy) propyl ketone, 1-hydroxycyclohexyl phenyl ketone, 2,2-dimethoxy-2-phenylacetophenone, 2-methyl-(4-methylthiophenyl)-2-morpholino-1-propan-1-one (Irgacure-907) or 2-benzyl-2-dimethylamino-1-(4-morpholinophenyl)-butan-1-one (Irgacure-369); an O-acyloxime compound such as Irgacure OXE 01, Irgacure OXE 02 by Ciba Geigy Corporation; a benzophenone-based compound such as 4,4′-bis (dimethylamino) benzophenone or 4,4′-bis (diethylamino) benzophenone; a thioxantone-based compound such as 2,4-diethylthioxanthone, 2-chlorothioxanthone, isopropylthioxanthone or diisopropylthioxanthone; a phosphine oxide-based compound such as 2,4,6-trimethylbenzoyldiphenylphosphine oxide, bis (2,6-dimethoxybenzoyl)-2,4,4-trimethylpentylphosphine oxide or bis (2,6-dichlorobenzoyl) propylphosphine oxide; a coumarin-based compound such as 3,3′-carbonylvinyl-7-(diethylamino) coumarin, 3-(2-benzothiazolyl)-7-(diethylamino)coumarin, 3-benzoyl-7-(diethylamino)coumarin, 3-benzoyl-7-methoxy-coumarin or 10,10′-carbonylbis[1,1,7,7-tetramethyl-2,3,6,7-tetrahydro-1H,5H,11H—Cl]-benzopyrano[6,7,8-ij]-quinolizin-11-one; alone or in combination of two or more, but is not limited thereto.

Further, the thermal initiator may use thermal initiators known in the art.

According to the exemplary embodiment of the present invention, the tackifier may include at least one selected from a group consisting of cycloaliphatic hydrocarbon polymers, aromatic hydrocarbon polymers, hydrogenated cycloaliphatic hydrocarbon polymers, and hydrogenated aromatic hydrocarbon polymers. Particularly, according to the exemplary embodiment of the present invention, the tackifier may be a hydro-dicyclopentadiene (DCPD)-based resin.

According to the exemplary embodiment of the present invention, the solvent may include one or 2 more selected from the group consisting of toluene, hexane, heptane, THF, cyclohexane, methyl ethyl ketone, methyl cellosolve, ethyl cellosolve, ethylene glycol dimethyl ether, ethylene glycol diethyl ether, propylene glycol dimethyl ether, propylene glycol diethyl ether, diethylene glycol dimethyl ether, diethylene glycol diethyl ether, diethylene glycol methyl ethyl ether, 2-ethoxypropanol, 2-methoxypropanol, 3-methoxybutanol, cyclohexanone, cyclopentanone, propylene glycol methyl ether acetate, propylene glycol ethyl ether acetate, 3-methoxybutyl acetate, ethyl 3-ethoxypropionate, ethyl cellosolve acetate, methyl cellosolve acetate, butyl acetate, and dipropylene glycol monomethyl ether. However, the solvent is not limited thereto.

According to the exemplary embodiment of the present invention, the content of the quantum dots may be 0.001 wt % or more and 25 wt % or less with respect to the total adhesive composition, the content of the hydrophobic olefin-based material may be 10 wt % or more and 50 wt % or less with respect to the total adhesive composition, and the content of the solvent may be 35 wt % or more and 85 wt % or less with respect to the total adhesive composition.

According to the exemplary embodiment of the present invention, the content of the additive may be 1 wt % or more and 50 wt % or less with respect to the total adhesive composition.

According to the exemplary embodiment of the present invention, the content of the crosslinking compound may be 1 wt % or more and 50 wt % or less with respect to the total weight of the adhesive composition.

According to the exemplary embodiment of the present invention, the content of the photoinitiator or the thermal initiator may be 0.1 wt % or more and 5 wt % or less based on the total weight of the adhesive composition, but is not limited thereto.

The adhesive composition according to the exemplary embodiment of the present invention may prevent the deterioration of performance of the quantum dots due to an excellent external blocking property. Specifically, the adhesive composition has excellent ability to protect the quantum dots from moisture and oxygen to prevent the performance of the quantum dots from deteriorating.

In the adhesive composition according to the exemplary embodiment of the present invention, since the quantum dots may be evenly distributed, even though a small amount of quantum dots is used, excellent performance may be implemented.

According to the exemplary embodiment of the present invention, the quantum dot may include II-VI group, III-V group, IV-VI group, and IV group semiconductors and semiconductors of mixtures thereof. The semiconductor material is not particularly limited, but may include Si, Ge, Sn, Se, Te, B, C, P, BN, BP, BAs, AlN, AlP, AlAs, AlSb, GaN, GaP, GaAs, GaSb, InN, InP, InAs, InSb, AlN, AlP, AlAs, AlSb, GaN, GaP, GaAs, GaSb, ZnO, ZnS, ZnSe, ZnTe, CdS, CdSe, CdₓSe_{y}S_{z}, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuInS₂, Cu₂SnS₃, CuBr, CuI, Si₃N₄, Ge₃N₄, Al₂O₃, (Al, Ga, In)₂ (S, Se, Te)₃, CIGS, CGS, (ZnS)_{y}(CuₓSn₁₋ₓS₂)_{1-y}, and a mixture of semiconductors thereof.

According to the exemplary embodiment of the present invention, the quantum dot may have a core/shell structure or an alloy structure. The quantum dot having the core/shell structure or the alloy structure may be CdSe/ZnS, CdSe/ZnSe/ZnS, CdSe/CdSₓ(Zn_{1-y}Cd_{y})S/ZnS, CdSe/CdS/ZnCdS/ZnS, InP/ZnS, InP/Ga/ZnS, InP/ZnSe/ZnS, PbSe/PbS, CdSe/CdS, CdSe/CdS/ZnS, CdTe/CdS, CdTe/ZnS, CuInS₂,/ZnS or Cu₂SnS₃/ZnS, but is not limited thereto.

According to the exemplary embodiment of the present invention, the quantum dot may include quantum dots representing at least one color selected from a group consisting of red light, green light, blue light and yellow light. The quantum dots may absorb ultraviolet light having a wavelength of about 100 nm to about 400 nm and visible light having a wavelength of about 380 nm to 780 nm.

The blue light may have an emission peak in a wavelength range of 410 nm or more to less than 500 nm, the green light may have an emission peak in a wavelength range of 500 nm or more to less than 550 nm, and the yellow light may have an emission peak in a wavelength range of 550 nm or more to less than 600 nm, and the red light may have an emission peak in a wavelength range of 600 nm or more to less than 700 nm. In this specification, for convenience, four colors of blue, green, yellow, and red are representatively expressed, but the wavelength range includes various colors such as orange, indigo, and violet in addition to these colors.

Another exemplary embodiment of the present invention provides an adhesive film including the adhesive composition.

Further, another exemplary embodiment of the present invention provides an adhesive film prepared by using the adhesive composition.

An exemplary embodiment of the present invention provides an adhesive film including at least a quantum dot in a substrate including an olefin polymer, in which at least one of repeated units of the olefin polymer is derived from isobutylene.

According to the exemplary embodiment of the present invention, the olefin polymer and the quantum dots in the adhesive film are the same as described above.

According to the exemplary embodiment of the present invention, a thickness of the adhesive film may be 10 μm or more and 500 μm or less. Particularly, according to the exemplary embodiment of the present invention, the thickness of the adhesive film may be 30 μm or more and 100 μm or less, or 40 μm or more and 70 μm or less.

The adhesive film within the thickness range may improve stability and a lifespan of quantum dots and enhance color purity without a change of an emission wavelength because the quantum dots are dispersed well without entanglement. Further, a thickness level required to simplify a device and form thinner lighting devices may be satisfied.

The adhesive film is prepared by using the olefin polymer having an excellent moisture and oxygen blocking property and has an excellent moisture and oxygen blocking property to improve durability of the quantum dots.

Further, the adhesive film is prepared by using an olefin polymer having excellent water resistance and has excellent water resistance to improve the durability of the quantum dots.

According to the exemplary embodiment of the present invention, oxygen permeability of the adhesive film may be 1.4×10⁻¹⁰ or less at 25° C. and the oxygen permeability value may be obtained by the following Equation 1.

Oxygen permeability={oxygen permeation volume(cm³)×thickness of adhesive film(cm²)}/{surface area of adhesive film in contact with oxygen(cm²)×time(s)×pressure drop when permeating adhesive film(cmHg)} [Equation 1]

According to the exemplary embodiment of the present invention, moisture permeability of the adhesive film may be 110×10⁻¹⁰ or less at 25° C. and the moisture permeability value may be obtained by the following Equation 2.

Moisture permeability={moisture permeation volume(cm³)×thickness of adhesive film(cm²)}/{surface area of adhesive film in contact with moisture(cm²)×time(s)×pressure drop when permeating adhesive film(cmHg)} [Equation 2]

According to the exemplary embodiment of the present invention, the adhesive film may be a color conversion film.

Further, according to the exemplary embodiment of the present invention, the adhesive film may be a quantum dot film.

The adhesive film according to the exemplary embodiment of the present invention may prevent the deterioration of performance of the quantum dots due to an excellent external blocking property. Particularly, the adhesive film has low oxygen permeability and low moisture permeability to have excellent ability to protect the quantum dots from moisture and oxygen and prevent deterioration of performance of the quantum dots.

The adhesive film according to the exemplary embodiment of the present invention has an advantage in that a deviation in performance is small because the quantum dots are evenly dispersed. Particularly, even though the adhesive film uses a small amount of quantum dots, the quantum dots are evenly dispersed and thus the adhesive film may exhibit excellent performance. Further, the adhesive film has an advantage of having a small performance deviation between specific regions because the quantum dots are evenly dispersed.

The adhesive film according to the exemplary embodiment of the present invention has an advantage of excellent adhesion with other substrates and high application.

Still another exemplary embodiment of the present invention provides a brightness enhancing film including the adhesive film and a light scattering layer provided on at least one surface of the adhesive film.

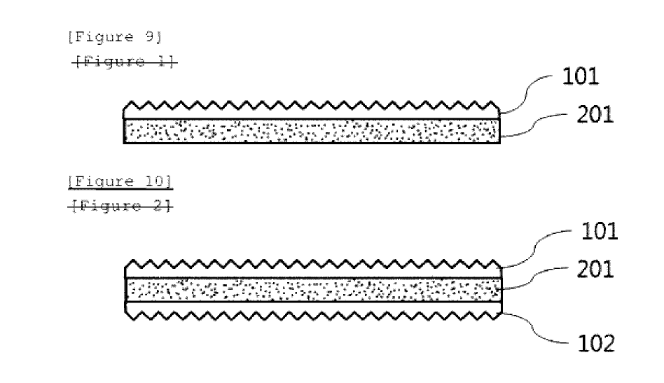

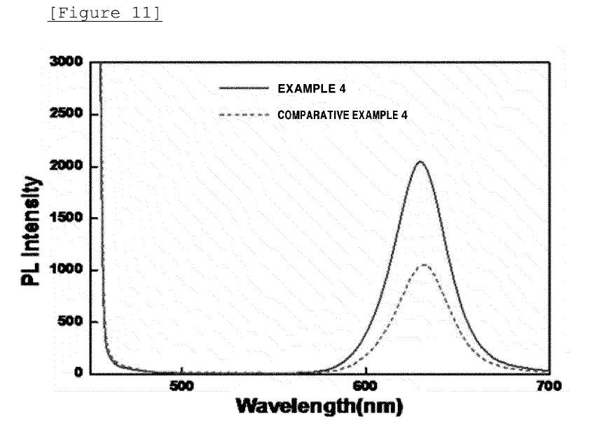

FIGS. 9 and 10 illustrate an example of a stacked structure of a brightness enhancing film according to an exemplary embodiment of the present invention. Particularly, FIG. 9 illustrates that a light scattering layer 101 is provided on an upper surface of an adhesive film 201 and FIG. 10 illustrates that light scattering layers 101 and 102 are provided on an upper surface and a lower surface of the adhesive film 201, respectively.

According to the exemplary embodiment of the present invention, the light scattering layer and the color conversion layer are directly in contact with each other and an air gap between the light scattering layer and the color conversion layer may be removed.

According to the exemplary embodiment of the present invention, the light scattering layer and the adhesive film are directly in contact with each other and an air gap between the light scattering layer and the adhesive film may be removed.

According to the exemplary embodiment of the present invention, since the adhesive film has excellent adhesion, when the adhesive film is attached to the light scattering layer, an air gap generated between the light scattering layer and the adhesive film may not be generated. Accordingly, the brightness enhancing film may implement high light emission efficiency and has an advantage of having excellent light extraction efficiency.

According to the exemplary embodiment of the present invention, the light scattering layer may be a prism layer in which a prism ridge is provided on one side.

According to the exemplary embodiment of the present invention, the prism ridge may include one or more inclined surfaces configuring one or more ridges and valleys.

According to the exemplary embodiment of the present invention, a height of the prism ridge may be 1 μm or more and 100 μm or less.

According to the exemplary embodiment of the present invention, a pitch of the prism ridge may be 1 μm or more and 200 μm or less.

According to the exemplary embodiment of the present invention, a cross-sectional shape of the prism ridge is not limited to a triangular shape and may be all shapes capable of refracting light, in which at least two optical planes capable of refracting the light are provided and at least a pair of surfaces are not parallel, such as a lenticular shape and a trapezoid shape.

According to the exemplary embodiment of the present invention, the brightness enhancing film may be a prism film. Further, the brightness enhancing film converts a wavelength of light received from the light source through the adhesive film including the quantum dots and the light having the converted wavelength may be more smoothly discharged through the light scattering layer. Furthermore, the brightness enhancing film minimizes the air gap between the adhesive film and the light scattering layer to minimize light lost between the adhesive film including the quantum dots and the light scattering layer, thereby enhancing efficiency.

Another exemplary embodiment of the present invention provides a backlight unit including the brightness enhancing film; a light source unit including a light source generating light; and a light guide plate guiding the light.

Yet another exemplary embodiment of the present invention provides a display device including a display panel and the backlight unit.

The display panel may be a liquid crystal display panel, an electrophoretic display panel, an electrowetting display panel, or the like.

The backlight unit may be disposed in a direction opposite to a direction in which an image is emitted from the display panel. The backlight unit may include a light guide plate, a light source unit including a plurality of light sources, an optical member, and a reflective sheet. Other configurations of the display device which are known in the art may be applied.

Hereinafter, the present invention will be described in detail with reference to Examples for a specific description. However, the Examples according to the present invention may be modified in various forms, and it is not interpreted that the scope of the present invention is limited to the Examples described in detail below. The Examples of the present invention will be provided for more completely explaining the present invention to those skilled in the art.

### Example 1

5 g of polyisobutylene, 3 g of a hydrogenated dicyclopentadiene (DCPD)-based adhesive, 1.9 g of trimethylolpropanetriacrylate (TMPTA), 0.1 g of a photo initiator IGR 184, and 30 g of toluene were mixed to prepare an adhesive composition.

1 wt % of CdSe/ZnS red quantum dots with respect to the total weight of the adhesive composition excluding a solvent of the adhesive composition were added and sonication was performed for 30 minutes to uniformly mix the quantum dots. Thereafter, the adhesive composition was coated on a polyethyleneterephthalate (PET) film through bar-coating. In order to completely remove the toluene contained in the adhesive composition, the PET film which was easily removed after heating in an oven at 100° C. for 10 minutes was laminated on an adhesive coating. In an UV curing machine (D-bulb), the film was cured with about 1,000 mJ/cm².

In addition, in order to verify dispersion of the quantum dots in the adhesive film formed by removing the PET film on the adhesive film, the dispersion was measured through a fluorescent microscope. In addition, in order to measure a change in photo luminescence (PL) intensity after a constant temperature and humidity condition, a change in PL intensity was measured at 85° C., for 1,000 hours in a thermostat with a moisture content of about 85% RH (relative humidity).

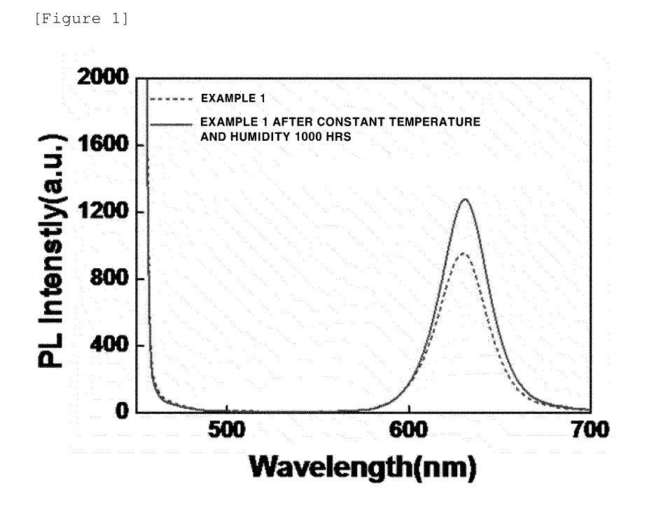

FIG. 1 illustrates a change graph of photo luminescence (PL) intensity before and after constant temperature and humidity of an adhesive film according to Example 1.

### Comparative Example 1

Except that trimethylolpropanetriacrylate (TMPTA) was used as a photocurable resin for film formation, a solvent was toluene, the photoinitiator used IRG184 and D-1173, and the solvent was mixed with 20 wt % with respect of the entire composition to prepare the composition, a film was prepared by the same method as the Example 1 and then a change in PL intensity was measured.

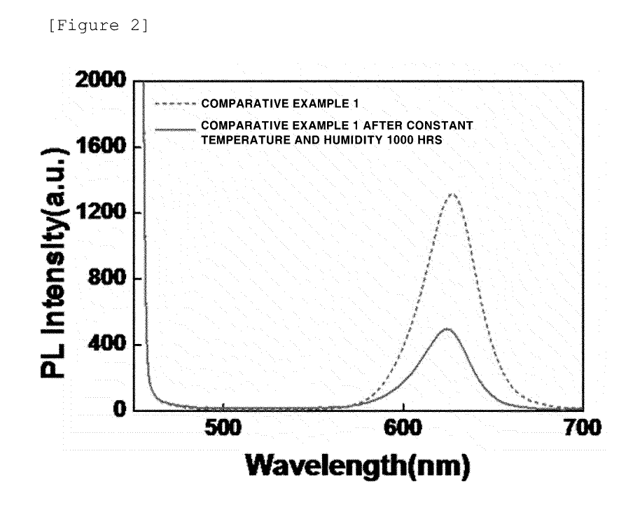

FIG. 2 illustrates a change graph of photo luminescence (PL) intensity before and after constant temperature and humidity of an acrylate film according to Comparative Example 1.

FIG. 3 illustrates a change graph of photo luminescence (PL) intensity during constant temperature and humidity of the films according to Example 1 and Comparative Example 1.

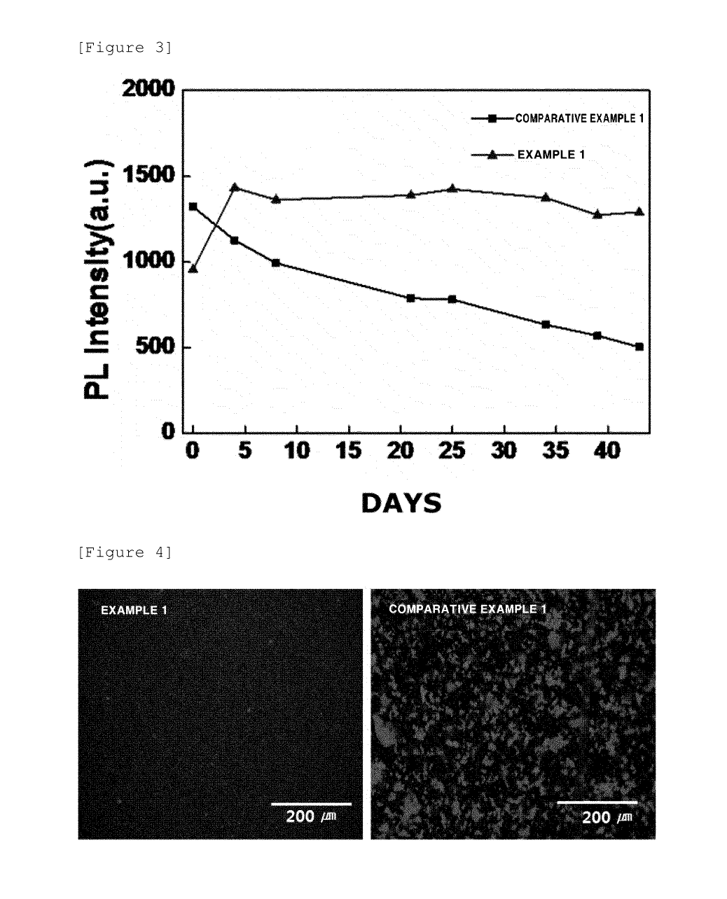

FIG. 4 is a fluorescent image of the films according to Example 1 and Comparative Example 1.

### Example 2

Except for using CdSe/ZnS green quantum dots, an adhesive film was prepared by the same method as the Example 1, and then in order to verify dispersion of the quantum dots in the adhesive film, the dispersion was measured by a fluorescent microscope.

### Comparative Example 2

Except for using CdSe/ZnS green quantum dots, a film was prepared by the same method as the Comparative Example 1, and then in order to verify dispersion of the quantum dots in the adhesive film, the dispersion was measured by a fluorescent microscope.

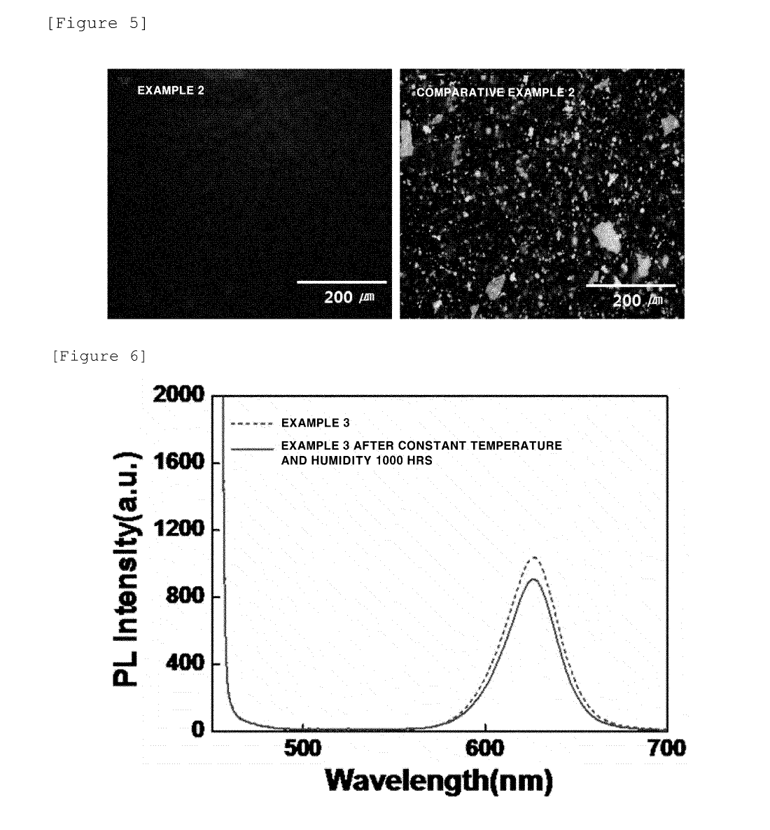

FIG. 5 is a fluorescent image of the films according to Example 2 and Comparative Example 2.

### Example 3

50 mg of polyethylene wax (PED 191, Clarient) was subdivided into a 20 ml vial and a solution added with 4.95 g of toluene was heated up to 90° C. The polyethylene wax was adjusted to a concentration of 1 wt % with respect to the solution.

As soon as the solution reached 90° C., a CdSe/ZnS red quantum dot solution at an appropriate concentration (standard: 25 mg/ml toluene) was injected, and the vial was put into a 50° C. water bath with a pre-set temperature and stirred at 200 rpm for 1 min by using a stirring bar. The vial was removed from the water bath after 1 min and left for 4 mins in the air, and the stirring bar was removed. The vial was left until being completely cooled and then collected by 20 g and divided into a conical tube, and centrifuged at 3,000 rpm for 5 min for washing. After centrifugation, a supernatant was discarded and the same volume of toluene was poured into a precipitated microcapsule and redispersed by vortexing. The above washing process was repeated three times to completely remove an unreacted material.

The polymer capsule containing the quantum dots formed above was put in the adhesive composition prepared in the Example 1 so as to have 16 wt % of a total weight excluding the solvent, and sonication was conducted for 30 minutes for uniformly mixing. Thereafter, the adhesive composition was coated on a polyethyleneterephthalate (PET) film through bar-coating. In order to completely remove the toluene contained in the adhesive composition, the PET film which was easily removed after heating in an oven at 100° C. for 10 minutes was laminated on an adhesive coating. In an UV curing machine (D-bulb), the film was cured with about 1,000 mJ/cm².

In addition, in order to verify dispersion of the quantum dots in the adhesive film formed by removing the PET film on the adhesive film, the dispersion was measured through a fluorescent microscope. In addition, in order to measure a change in photo luminescence (PL) intensity after a constant temperature and humidity condition, a change in PL intensity was measured while being stored for 1,000 hours in a thermostat with a moisture content of about 85% RH (relative humidity) at 85° C.

FIG. 6 illustrates a change graph of photo luminescence (PL) intensity before and after constant temperature and humidity of an adhesive film according to Example 3.

### Comparative Example 3

A film was formed by using a composition using a polymer capsule containing the quantum dots prepared by the same method as the Example 3, trimethylolpropanetriacrylate (TMPTA), toluene as a solvent, and IRG184 and D-1173 as the photoinitiator. The content of the polymer capsule containing the quantum dots in the composition was 16 wt % of the total weight except for the solvent in the composition and the content of the solvent was 20 wt % with respect to the entire composition.

By the using the composition, the film was prepared by the same method as the Example 3 and then a change in PL intensity was measured.

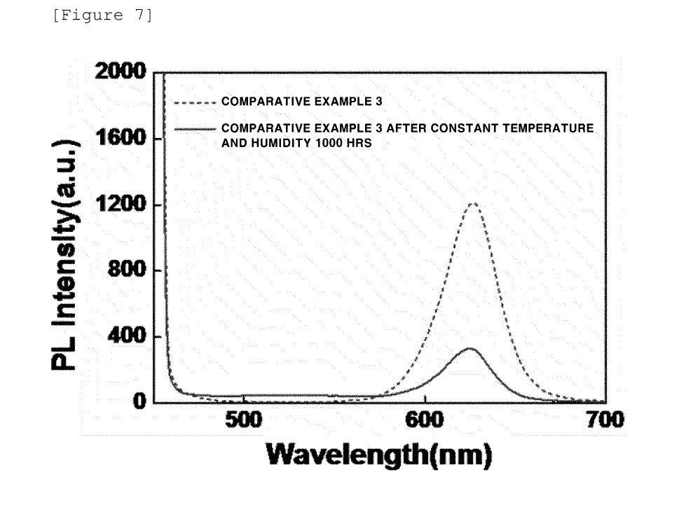

FIG. 7 illustrates a change graph of photo luminescence (PL) intensity before and after constant temperature and humidity of an adhesive film according to Comparative Example 3.

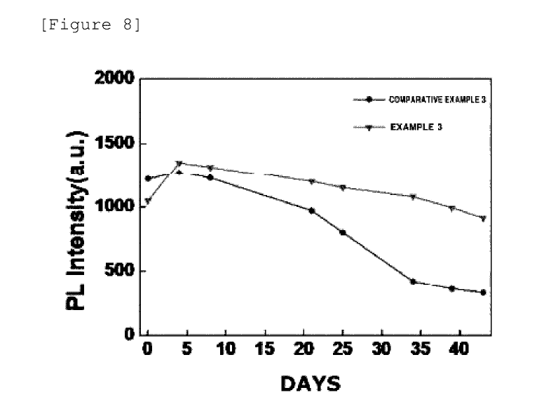

FIG. 8 illustrates a change graph of photo luminescence (PL) intensity during constant temperature and humidity of the films according to Example 3 and Comparative Example 3.

It can be seen that quantum yield of the adhesive film containing the quantum dots at the same concentration according to Example is increased by 15% to 20% as compared with an acryl resin film according to Comparative Example and less red-shift of the emission wavelength occurs.

Particularly, when comparing results of the Example and the Comparative Example, it can be seen that the dispersion of the quantum dots observed through a fluorescent microscope of the adhesive film according to the Example is excellent.

Further, it can be seen that the adhesive film according to the Example has excellent stability of the quantum dots even under the constant temperature and humidity condition.

### Example 4

5 g of polyisobutylene, 3 g of a hydrogenated dicyclopentadiene (DCPD)-based adhesive, 1.9 g of trimethylolpropanetriacrylate (TMPTA), 0.1 g of a photo initiator IGR 184, and 30 g of toluene were mixed to prepare an adhesive composition.

1 wt % of CdSe/ZnS red quantum dots with respect to the total weight of the adhesive composition excluding a solvent of the adhesive composition were added and sonication was performed for 30 minutes to uniformly mix the quantum dots. Thereafter, the adhesive composition was coated on a polyethyleneterephthalate (PET) film through bar-coating. In order to completely remove the toluene contained in the adhesive composition, the PET film which was easily removed after heating in an oven at 100° C. for 10 minutes was laminated on an adhesive coating. In a UV curing machine (D-bulb), the film was cured with about 1,000 mJ/cm² to prepare the adhesive film.

In addition, the PET film on the adhesive film was removed, a prism sheet having a prism pitch of 50 μm and a height of 20 μm was laminated on the adhesive film in a vacuum state so as to minimize an air gap to prepare a brightness enhancing film and then a change in photo luminescence (PL) intensity was measured.

### Comparative Example 4

Like the Example 4, the adhesive film was prepared, and then the PET film on the adhesive film was removed, a prism sheet having a prism pitch of 50 μm and a height of 20 μm was placed thereon so that an air gap was present, and thereafter, a change in photo luminescence (PL) intensity was measured.

FIG. 11 illustrates a comparison graph of photo luminescence (PL) intensity according to presence of an air gap between a light extraction layer and an adhesive film in brightness enhancing films according to an Example and a Comparative Example.

As illustrated in FIG. 11, it can be seen that the PL intensity of the brightness enhancing film from which the air gap was removed according to the exemplary embodiment of the present invention is excellent as compared with the case where the air gap is present.

1. A brightness enhancing film, comprising:
a color conversion layer including at least one quantum dot in a substrate including an olefin polymer; and
a light scattering layer provided on at least one surface of the color conversion layer,
wherein at least one of repeated units of the olefin polymer is derived from isobutylene.

2. The brightness enhancing film of claim 1, wherein at least one of repeated units of the olefin polymer includes two methyl side chains.

3. The brightness enhancing film of claim 1, wherein the olefin polymer has a glass transition temperature of −50° C. or less.

4. The brightness enhancing film of claim 1, wherein the olefin polymer is a random copolymer formed by polymerizing one or more kinds of monomers selected from a group consisting of isopropylene and isobutylene.

5. The brightness enhancing film of claim 1, wherein at least some or all of the surfaces of the quantum dots are coated with a transparent organic or inorganic polymer material.

6. The brightness enhancing film of claim 1, wherein a thickness of the color conversion layer is 10 μm or more and 500 μm or less.

7. The brightness enhancing film of claim 1, wherein oxygen permeability of the color conversion layer is 1.4×10⁻¹⁰ or less at 25° C. and the oxygen permeability value is obtained by the following Equation 1.
Oxygen permeability={oxygen permeation volume(cm³)×thickness of adhesive film(cm²)}/{surface area of adhesive film in contact with oxygen(cm²)×time(s)×pressure drop when permeating adhesive film(cmHg)} [Equation 1]

8. The brightness enhancing film of claim 1, wherein moisture permeability of the color conversion layer is 110×10⁻¹⁰ or less at 25° C. and the moisture permeability value is obtained by the following Equation 2.
Moisture permeability={moisture permeation volume(cm³)×thickness of adhesive film(cm²)}/{surface area of adhesive film in contact with moisture(cm²)×time(s)×pressure drop when permeating adhesive film(cmHg)} [Equation 2]

9. The brightness enhancing film of claim 1, wherein the light scattering layer and the color conversion layer are directly in contact with each other and an air gap between the light scattering layer and the color conversion layer is removed.

10. The brightness enhancing film of claim 1, wherein the light scattering layer is a prism layer in which a prism ridge is provided on one side.

11. The brightness enhancing film of claim 10, wherein the prism ridge includes one or more inclined surfaces configuring one or more ridges and valleys.

12. The brightness enhancing film of claim 10, wherein a height of the prism ridge is 1 μm or more and 100 μm or less.

13. The brightness enhancing film of claim 10, wherein a pitch of the prism ridge is 1 μm or more and 200 μm or less.

14. A backlight unit, comprising:
the brightness enhancing film according to claim 1;
a light source unit including a light source generating light; and
a light guide plate guiding the light.
